(19) United States
(12) Patent Application Publication
(10) Pub. No.: US 2015/0332277 A1
(43) Pub. Date: Nov. 19, 2015

(54) COMPLIANCE ADHERENCE ASSESSMENT TOOL FOR REGULATORY REPORTING

(71) Applicant: BANK OF AMERICA CORPORATION, Charlotte, NC (US)

(72) Inventors: Makarand Manohar Bhosale, Panchpakhadi (IN); Ronald Zurinskas, Charlotte, NC (US); Wai Meng Yip, Hong Kong (HK); Vikas Madhukar Mahankale, Pune (IN)

(73) Assignee: BANK OF AMERICA CORPORATION, Charlotte, NC (US)

(21) Appl. No.: 14/276,307

(22) Filed: May 13, 2014

(51) Int. Cl. G06Q 30/00; G06Q 40/00

(52) U.S. Cl. CPC G06Q 30/018; G06Q 40/12

(57) ABSTRACT

Embodiments of the invention are directed to a system, method, or computer program product for a compliance adherence assessment tool for regulatory reporting. The tool provides a self-explaining check for and evaluation of completeness of a compliance regulatory report. In this way, irrespective of the location or group within an entity, the report is generated from, the processing and compliance adherence will be uniform across the entity. Furthermore, the tool aids in creating a uniform reporting process that weighs potential exposures and mitigates those exposures for regulatory reporting across an entity.

### BACKGROUND

Typically, regulatory reporting for an entity may be outlined in an entity wide reporting policy. This policy may closely follow both federal and local regulatory guidelines for reporting to regulators in a similar fashion. However, the process of generating the reports may still differ in appearance and/or scope based on where the report is generated, such as a different country or different group within an entity. The compliance adherence portion of the entity may then be able to review the reports from the various groups.

Entity reviews of regulatory reports may typically occur via backend auditing functionality within the entity. As such, uniform processing and reports generated for compliance reporting is ensured via the auditing process.

### BRIEF SUMMARY

The following presents a simplified summary of all embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of all embodiments in a simplified form as a prelude to the more detailed description that is presented later.

Embodiments of the present invention address the above needs and/or achieve other advantages by providing apparatus (e.g., a system, computer program product, and/or other devices) and methods for a compliance adherence assessment tool for financial regulatory reporting. As such, providing a self-explaining check for and evaluation of completeness of a compliance regulatory report. In this way, irrespective of the group the report is generated from, the processing and desktop procedures for reporting will be uniform across the entity to ensure accuracy of reporting prior to auditing scenarios. Thus, supporting and accelerating completeness of front end compliance reporting and providing instant audit readiness. Furthermore, creating a uniform reporting processing mitigates any discrepancies between the various processes that may have occurred.

In some embodiments, the invention initiates by downloading a bundled package for preparation of building the compliance adherence assessment tool for regulatory reporting. The bundled package includes the entity's global regulatory reporting policy, procedure assessment tools, key contact information, desktop procedure templates, and desktop procedure addendums. The entity's global regulatory reporting policy is a policy implemented by the entity for reporting financials. In some embodiments, the bundled package includes procedure assessment tools. Procedure assessment tools provide a tool for standardization of the specific procedures that need to be followed to complete the report and prepare for audit readiness. The procedure assessment tool may include several features which are described in more detail below. These features may include incorporating checklist items for each report, generating a status update for each of the checklist items of the report, creating value scores for the exposure items of each of the checklist items, presenting grids associated with exposure impact for each of the one or more exposure items, allowing authorized users 202 input into exposure element rankings, and the

In some embodiments, also included in the bundled package for preparation of application of the compliance adherence assessment tool for regulatory reporting includes the key contacts for that report. In some embodiments, the bundled package includes a desktop procedure template for each of the reports. Finally, the bundle package includes any desktop procedure addendum that may be required for the particular report based on updates received from the entity and/or the local or federal regulators.

Once the bundled package of information required for that particular financial report desktop procedures has been downloaded, the invention may continue by having the preparer of the report run the assessment tool. The tool incorporates the bundled package of data with data inputted from a preparer and the report. Once ran, the tool may continue to monitor and access the current status of the report, which includes one or more checklist items for the report. In this way, the tool may run all checklists and indicate to a user the missing portions of the report. These checklists monitored by the assessment tool includes monitoring whether procedures were correctly followed for that report, objectives for the report were clear and met, the report history, the report frequency, and the like.

In some embodiments, the compliance adherence assessment tool may then internally measure the potential gaps in the regulatory reporting process. In this way, the tool may identify one or more exposure areas or other gaps in the reporting process for that particular financial report and group associated therewith. As such, the desktop procedures for the new report may fill these gaps such that the reports may be compliant and adherent.

In some embodiments, a user may, at any time, review and assess the status of the compliance adherence assessment tool for regulatory reporting via an interface. In this way, a compliance adherence assessment tool for regulatory reporting is presented to the appropriate user within the entity. The interface may be presented to a preparer, a manager, or the like. The preparer and manager may view different assessment tool interfaces depending on authorization. The preparer may identify the items, the checklist, and the status of completion of each of the items. Each of the items may vary depending on the global regulatory reporting policy and/or local regulations for that particular financial report.

The manager's self assessment tool may include several columns that a manager may have access to. The manager's self assessment tool allows the manager to include a weighted combination value of the exposures for each of the checklist times within the report. Furthermore, the manager may be able to edit the ranking number given for the exposure element of each checklist item. In this way, the manager may be able to identify the one or more items that may have the most potential negative exposure if not mitigated. In this way, the manager may be able to input into the self assessment tool one or more indications as to how much exposure each item may have on the manager's line of business. In this way, compliance associates and other users may be able to identify the one or more areas that may require more review to ensure a mitigation of exposure for that financial report. Furthermore, the manager may be able to view, via an audit readiness interface, the readiness for auditing prepared by the system.

In some embodiments, once the manager reviews the compliance adherence assessment tool, the invention may provide documentation of the appropriate procedure template for the specific financial report data. In this way, the selected template may match the required global regulatory reporting policy and regulations associated with the same. In this way, the preparer has completed all or most of the checklist to ensure compliance adherence and the report is being generated based on the desktop procedure template and desktop procedure addendums identified for the report.

Once the template is generated for the report, the data for the report has been inputted and can again be reviewed via the compliance adherence assessment tool. The manager or business controller may have access to view the exposure for each of the checklist items. The manager may also have the ability to manually input a number or weight to each of the exposure elements across each checklist item to identify the highest importance exposure for that particular group within the entity for subsequent mitigation of the exposure.

In some embodiments, once the manager inputs scores for exposure elements, the invention may apply logic to calibrate the points or rankings inputted by the manager. In some embodiments, the logic applied may correlate to generate an the audit readiness interface that provides a quick look into the preparedness of the report and data associated therewith for auditing.

In some embodiments, once logic has been applied to calibrate and weigh the points associated with exposure elements associated with each of the one or more checklist items for a desktop procedure, the invention may continue to queue reports with high exposure elements for further mitigation.

Subsequently, the invention continues to generate and update the procedures documentation with the mitigation associated therewith. A subsequent review and control of the desktop procedures may be performed by a user. In some embodiments, the system may then confirm that the correct desktop procedures template for the particular report is accurate and correct. If correct, the desktop procedure may be presented, and data may be inputted into the same for report completion and audit readiness.

Embodiments of the invention relate to systems, methods, and computer program products for compliance adherence tools for financial regulatory reporting, the invention comprising: generating a procedure template for regulatory reporting; updating the procedure template with policies and local regulations for a specific financial report; presenting assessment tool for the financial report to a user via an interface, wherein the assessment tool provides a checklist of items to complete for compliance and an order associated therewith; receiving ranking of exposure elements for each of the checklist of items; applying logic to received ranking of exposure elements to identify weighted exposure ranking for each of the checklist of items to identify impactful exposures, wherein the weighted exposure rank is based on the received rank of the exposure elements, the checklist item associated with the exposure elements, and the financial report; updating the procedures template for the financial report with mitigation steps for the impactful exposures, wherein the updating creates a unique procedures template for the financial report; providing the unique procedures template to initiate financial report creation; and creating uniform financial reports across an entity using unique procedures templates created for each of the required financial reports across the entity.

In some embodiments, the invention further comprises generating an audit readiness assessment tool displaying the readiness of each of the financial reports across the entity based on the mitigation steps completed for the impactful exposures for the financial reports.

In some embodiments, presenting the assessment tool further comprises determining the authorization level of the user being presented with the assessment tool and changing an amount of data presented to the user based on the authorization level of the user. In some embodiments, the assessment tool further comprises an input for ranking a negative exposure for each of the checklist items across each of the exposure elements.

In some embodiments, the exposure factors include one or more of regulatory exposures, legal exposures, or monetary exposure.

In some embodiments, the unique procedures template further comprises reporting frequency, key contacts, and procedures unique to each of the financial reports required for an entity.

In some embodiments, the invention further comprising receiving a global regulatory reporting policy from the entity and local regulations to incorporate into the procedure template for the financial report associated with the global regulatory reporting policy from the entity or local regulations.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a high level process flow illustrating the process of the compliance adherence assessment tool for regulatory reporting, in accordance with embodiments of the invention;

FIG. 2 provides an illustration of a compliance adherence assessment tool for regulatory reporting system environment, in accordance with various embodiments of the invention;

FIG. 3 provides a process flow illustrating the regulatory reporting compliance adherence assessment technique, in accordance with embodiments of the invention;

FIG. 4 provides a detailed process illustrating the process of calibrating for identification of high exposure reports, in accordance with an embodiment of the invention;

FIG. 5 provides an illustration of an assessment tool interface associated with the compliance adherence assessment tool for regulatory reporting, in accordance with embodiments of the invention;

FIG. 6 provides an illustration of an assessment tool interface associated with the compliance adherence assessment tool for regulatory reporting, in accordance with embodiments of the invention; and

FIG. 7 provides an illustration of items within desktop procedures generated for a regulatory report, in accordance with embodiments of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

Furthermore, embodiments of the present invention use the term “user.” It will be appreciated by someone with ordinary skill in the art that the user may be an individual, financial institution, corporation, or other entity that may have documents associated with accounts, transactions, or the like with the entity providing the system. The term “group” as presented herein may refer to one or more lines of business, groups, subsidiaries, business partners, or the like that are associated with an entity that has financial regulatory reporting.

The term “reporting policy” or “reporting procedure” as used herein may refer to any policy or procedure put in place by an entity and/or a government for reporting requirements for the entity. Reporting may include any reporting of financials associated with the entity.

Although some embodiments of the invention herein are generally described as involving a “financial institution,” one of ordinary skill in the art will appreciate that other embodiments of the invention may involve other businesses that take the place of or work in conjunction with the financial institution to perform one or more of the processes or steps described herein as being performed by a financial institution. Still in other embodiments of the invention the financial institution described herein may be replaced with other types of entities that have electronic document or data storage needs.

Typically, large entities may have a global reporting process laying out the processing and formatting of reports for financial reporting. However, each group within the entity is responsible for creating the necessary reporting for that group. These groups may be in different geographic locations, different services within the entity, or the like. As such, while global reporting processes may be laid out, the data may be construed differently across the various groups within the entity. Back end auditing procedures are in place to monitor data post reporting. As such, a need exists for filling gaps in financial reporting such that generated reports view data and present reports in a similar manner.

In this way, a compliance adherence assessment tool for regulatory reporting is provided herein that creates an all in one bundled package that accelerates and mitigates exposure associated with the reporting completeness and audit reediness. The tool allows for self-explaining checks towards compliance and evaluation of completeness. The tool also measures the level of exposure and impacts of the report data. The tool allows for identification of a lead user for the report, user assessment of the report, and continuity between reports for reporting and/or auditing.

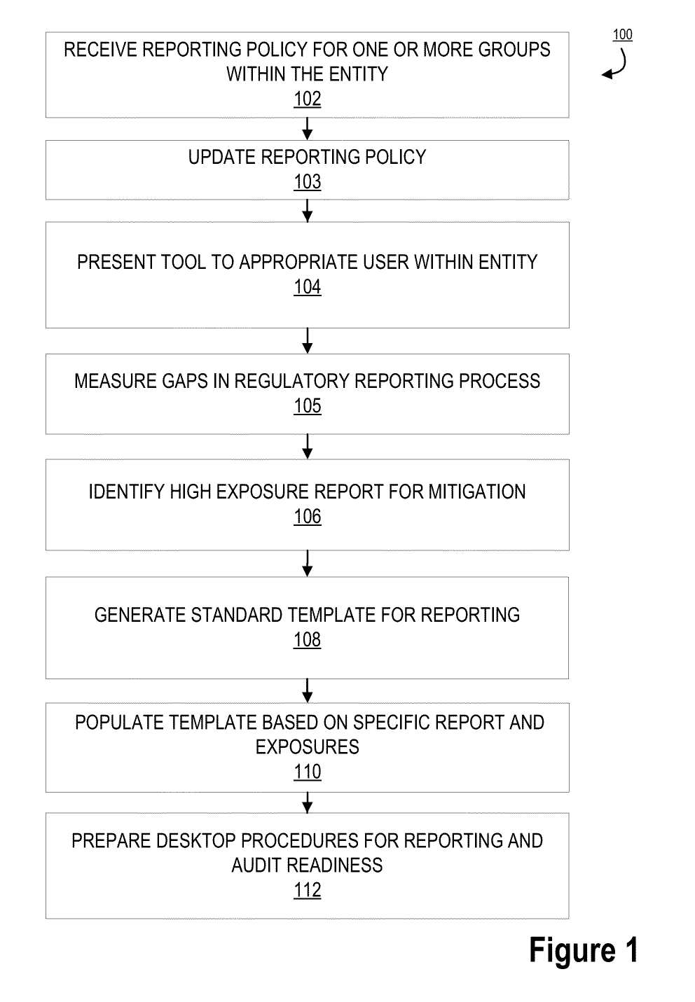

FIG. 1 provides a high level process flow illustrating the process of the compliance adherence assessment tool for regulatory reporting 100, in accordance with embodiments of the invention. As illustrated in block 102, the process 100 is initiated when the system receives reporting policies for one or more groups within the entities. In this way, a compliance group may provide updates or new reporting procedure documentation for each group within the entity that may have financial reporting obligations. Furthermore, the received reporting policies may also include local or federal regulations for financial reporting. In this way, the procedures received for the one or more groups within the entity may include internal and external reporting procedures and requirements as well as any updates for the same.

Next, as illustrated in block 103, the system updates the reporting policy for each of the various policies received. In this way, the report procedure for each group or each required report will be updated with the most current requirements and formats. Allowing for uniform reporting across an entity with similar data reporting across those groups for accurate data reporting.

Next, as illustrated in block 104, a compliance adherence assessment tool for regulatory reporting is presented to the appropriate user within the entity. The user may be one or more of a business controller, manager, compliance personnel, or other associates associated with the entity. In some embodiments, the tool is tailored to the individual user, such that more or less information is presented based on the user.

Next, as illustrated in block 105, the process 100 may continue by measuring potential gaps in the regulatory reporting process. In this way, the system may identify one or more exposure areas or other gaps in the reporting process for that particular financial report and group associated therewith.

As illustrated in block 106, the process 100 continues by identifying the high exposure reports for mitigation. The high exposure reports may be identified by calibrating one or more scores generated from a checklist of items associated with the report. The item checklist may be propagated with numbers correlated to ranks provided by the system or a user, such as a lead associate. These rankings may not be weighed equally based on logic applied to the particular checklist item and particular financial report.

The process 100 continues by generating a standard template for desktop procedures for reporting, as illustrated in block 108. In this way, a standardized procedure or protocol will be provided. Next, as illustrated in block 110 the template may be populated based on specific reporting and exposures. In this way, the template may be tailored for the particular report, information within the report, and/or the final destination of the report.

Finally, the system prepares the completed desktop procedures for reporting and audit readiness. In this way, the populated desktop procedures for compliance and regulatory reporting is finalized and the system takes the data and prepares it for audit readiness. Audit readiness compiles the data into one or more formats for easy audit viewing and responsiveness.

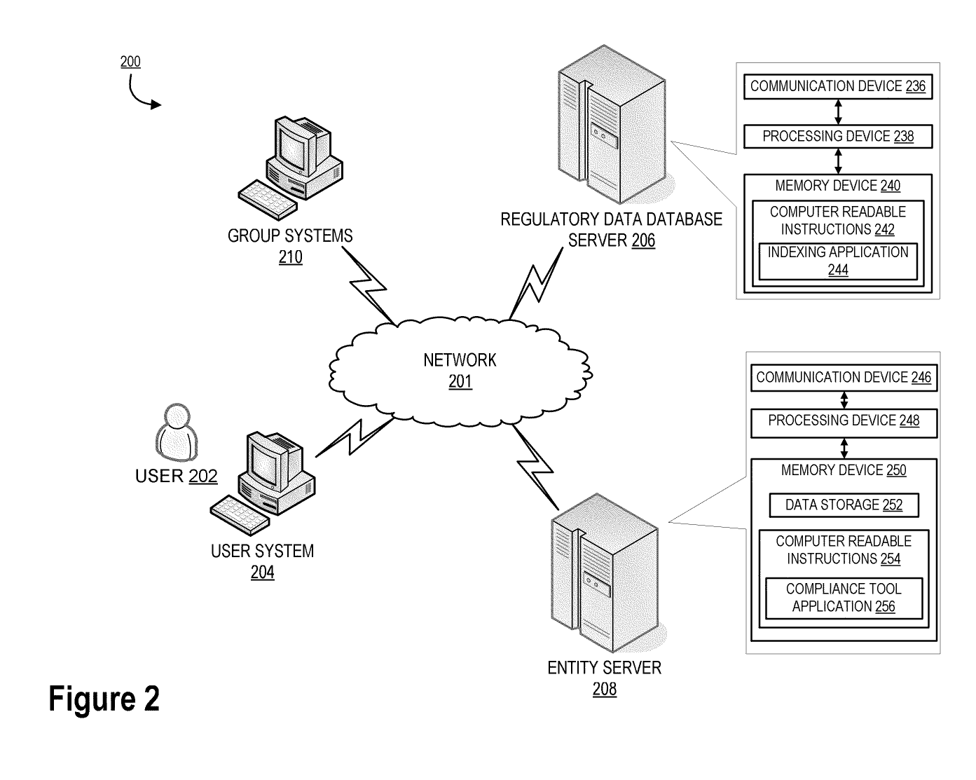

FIG. 2 illustrates a compliance adherence assessment tool for regulatory reporting system environment 200, in accordance with various embodiments of the invention. As illustrated in FIG. 2, the entity server 208 is operatively coupled, via a network 201 to the user system 204, the regulatory data database server 206, and the group systems 210. In this way, the entity server 208 can send information to and receive information from the user system 204, regulatory data database server 206, and the group systems 210 to provide for user document indexing and presentment.

FIG. 2 illustrates only one example of an embodiment of a compliance adherence assessment tool for regulatory reporting system environment 200, and it will be appreciated that in other embodiments one or more of the systems, devices, or servers may be combined into a single system, device, or server, or be made up of multiple systems, devices, or servers.

The network 201 may be a global area network (GAN), such as the Internet, a wide area network (WAN), a local area network (LAN), or any other type of network or combination of networks. The network 201 may provide for wireline, wireless, or a combination wireline and wireless communication between devices on the network.

In some embodiments, the user 202 is an individual that an affiliation with the entity reporting. In this way, the user 202 may be an employee, preparer of the report, manager, associate, customer, vendor, or the like associated with the entity. In some embodiments, the user 202 may be a group manager or business manager for the entity. In this way, the user 202 may be granted more access to information regarding financial reporting and also able to input rankings for the same. Furthermore, multiple individuals or entities may comprise a user 202, such as a group within the entity or multiple associates.

As illustrated in FIG. 2, the entity server 208 may include a communication device 246, processing device 248, and a memory device 250. The processing device 248 is operatively coupled to the communication device 246 and the memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device. The processing device 248 uses the communication device 246 to communicate with the network 201 and other devices on the network 201, such as, but not limited to the user system 204, group systems 210, and/or regulatory data database server 206 over a network 201. As such, the communication device 246 generally comprises a modem, server, or other device for communicating with other devices on the network 201.

As further illustrated in FIG. 2, the entity server 208 comprises computer-readable instructions 254 stored in the memory device 250, which in one embodiment includes the computer-readable instructions 254 of a compliance tool application 256. In some embodiments, the memory device 250 includes data storage 252 for storing data related to the compliance tool application 256 including but not limited to data created and/or used by the compliance tool application 256.

In the embodiments illustrated in FIG. 2 and described throughout much of this specification, the compliance tool application 256 receiving data for regulatory reporting, retrieves and downloading bundled package, generates an assessment tool for user 202 review, applies logic for exposure elements, selects and generates appropriate desktop procedures for report, and generates documentation for audit readiness.

In some embodiments, the compliance tool application 256 may receive data for regulatory reporting. The data may be received through the network 201 from the systems on the network, such as, but not limited to the group systems 210, the user system 204, or the regulatory data database server 206. The data received from the group systems 210 may include data from groups within the entity that have compiled the data over the course of a reporting period for the report. In some embodiments, this data may also be received from a compliance group within the entity.

In some embodiments, the compliance tool application 256 may generate a procedure assessment tool, desktop procedure templates, and desktop procedure addendums for the compliance adherence assessment and regulatory reporting tool. In this way, the compliance tool application 256 may review and create a procedure assessment tool for any number of users 202. As such, the compliance tool application 256 may tailor the data viewable via the procedure assessment tool based on the user 202 authorization. As such, the compliance tool application 256 may provide exposure elements and input options to a manager via a procedure assessment tool while not displaying exposure issues to other users. In this way, the compliance tool application 256 may create the procedure assessment tool for a user 202 to view and ensure compliance adherence for each report being generated across an entity. The procedure assessment tool may include several features which are described in more detail below. These features may include incorporating checklist items for each report, generating a status update for each of the checklist items of the report, creating value scores for the exposure items of each of the checklist items, presenting grids associated with exposure impact for each of the one or more exposure items, allowing authorized users 202 input into exposure element rankings, and the like.

The compliance tool application 256 may also create the initial desktop procedures templates. These templates are the templates for the regulatory reports that are all formatted similarly. In this way, any report that is generated by the entity may be formatted and processed the same, thus increasing accuracy across the reporting entity. The desktop procedures templates may all be similar, but be tailored slightly based on the type of financial data being reported, the location of the group reporting, and/or the like. These desktop procedures templates are monitored and updated regularly based on changes in the global regulatory reporting policy, local reporting regulations, or the like. Once the compliance tool application 256 has created a desktop procedures template, the template is communicated to the regulatory data database server 206, and more specifically the indexing application 244 for storage.

The compliance tool application 256 may also create any desktop procedure addendums. The addendums may be one or more updates to the one or more desktop procedure templates based on changes in the global regulatory reporting policy, changes in local regulations, changes in federal regulations, or the like. Once the addendums are posted, the compliance tool application 256 may communicate the addendums to the indexing application 244 for storage.

In some embodiments, the compliance tool application 256 may retrieve and download bundled package from the indexing application 244. As stated above, many of the bundle package items have been created by the compliance tool application 256 and communicated to the indexing application 244 for storage. When needed the compliance tool application 256 may request the information from the indexing application 244. The indexing application 244 may collect the necessary bundled package data from one or more sources and store it for the compliance tool application 256. The bundle package data includes the entity's global regulatory reporting policy, procedure assessment tools, key contact information, desktop procedure templates, and desktop procedure addendums.

In some embodiments, the compliance tool application 256 may apply logic for exposure elements. In this way, a user 202 may have previously inputted a value, score, number, weight or the like into a grid column corresponding to the negative impact that a particular exposure element may have on each of the checklist items and the report overall. The compliance tool application 256 may receive ranking data, in the form of scores, for the exposure elements contributing to potential negative exposure for one or more checklist items for a financial regulator report that the user 202 inputted onto the procedure assessment tool. The compliance tool application 256 may calibrate and weigh the received ranking data as well as the overall report topic. In this way, for each exposure element, the weight may be different depending on the financial report that is being generated or audited. As such, the weighing of the exposure elements may be fluid and applied differently at each report depending on the nature of the report and exposure potential for each report within the entity.

The compliance tool application 256 may then determine an overall exposure and/or audit readiness for each report. Furthermore, the compliance tool application 256 may determine an overall value of exposure for each of the checklist items associated with the report. These values may be determined based on logic. The logic applied may be an algorithm, learned artificial intelligence based on prior weeks/months/years of reporting, manager input, or the like and/or a combination thereof. As such, while some checklist items may receive one or more scores for exposure elements, these scores may be weighted more or less based on the particular exposure, the group, the report topic, or the like. The logic identifies the high exposure reports for mitigation.

In this way, the compliance tool application 256 may provide an overall exposure as well as a drilled down exposure for each checkpoint item. In this way, a user 202 may be able to identify specific items that contribute to one or more exposures that may need to be mitigated.

In some embodiments, the compliance tool application 256 may select and generate an appropriate desktop procedure for the report. In this way, the appropriate desktop procedure will be generated with the correct policies and data input for the report being generated. Once generated and all exposures mitigated appropriately, the compliance tool application 256 may allow for user 202 review and authorization of completion.

Finally, in some embodiments, the compliance tool application 256 may generate documentation for audit readiness by finalizing the desktop procedures for the preparer and prepare it for report submission and audit readiness storage.

As illustrated in FIG. 2, the regulatory data database server 206 generally comprises a communication device 236, a processing device 238, and a memory device 240. The processing device 238 is operatively coupled to the communication device 236 and the memory device 240. The processing device 238 uses the communication device 236 to communicate with the network 201 and other devices on the network 201, such as, but not limited to the entity server 208, the group systems 210, and the user system 204. As such, the communication device 236 generally comprises a modem, server, or other device for communicating with other devices on the network 201.

As further illustrated in FIG. 2, the regulatory data database server 206 comprises computer-readable instructions 242 stored in the memory device 240, which in one embodiment includes the computer-readable instructions 242 of an indexing application 244. In some embodiments, the memory device 240 includes database storage for storing data related to the indexing application 244 including but not limited to data created and/or used by the indexing application 244.

In the embodiments illustrated in FIG. 2 and described throughout much of this specification, the indexing application 244 generates and stores portions of the bundled packet for the compliance tool application 256 which includes, identifying, retrieving, or creating the global regulatory reporting policy, the procedure assessment took, key contacts for the report, desktop procedure templates, and desktop procedure addendums. The indexing application 244 also allows for the storage of templates and storage of data received for reporting.

As detailed above the compliance tool application 256 may communicate with the indexing application 244 to retrieve and store data to include in the bundled package for preparation of utilizing the compliance adherence assessment tool. The bundled package includes the entity's global regulatory reporting policy, procedure assessment tools, key contact information, desktop procedure templates, and desktop procedure addendums. As detailed above the compliance tool application 256 provides the indexing application 244 with one or more of the procedure assessment tools, desktop procedure templates, and desktop procedure addendums that the compliance tool application 256 may create for each of the one or more financial reports. The compliance tool application 256 may provide the indexing application 244 with the completed procedure assessment tools, desktop procedure templates, and desktop procedure addendums for storage until needed. When needed, the indexing application 244 application may retrieve the stored data and present it to the compliance tool application 256.

In some embodiments, the indexing application 244 may retrieve the entity's global regulator reporting policy and/or local and federal regulatory requirements for reporting. The data retrieved by the indexing application 244 may include new global regulatory compliant procedures or updates to current procedures. In some embodiments, the indexing application 244 may also receive data from outside the network 201 such as data from one or more local or federal government sources that may require specific financial reporting.

The entity's global regulatory reporting policy is a policy implemented by the entity for reporting financials. This report may include what data to include in reporting, how to use the data for reporting, logistics of the reporting (i.e. when to report, whom to report to, formatting of the report, or the like), or the like. The global regulatory reporting policy may include instructions or information about how the entity requires reporting procedures to be done for each of the one or more groups and/or financial reports. In this way the global regulatory reporting policy includes entity wide and local group policies about reporting each of the one or more finances that may require reporting.

In some embodiments, the indexing application 244 may identify and retrieve key contact information for each of the reports. As such, the indexing application 244 may review the report data and determine the appropriate user 202 whom may be a key contact for the report. This user 202 may be a manager or associated with the group generating the report. The key contact 3 may be a contact within the group within the entity associated with the report may be listed in the tool such that he/she may be contacted for additional data, for the key contact's review of the report, or the like. In this way, contact information for the key contact responsible for the specific financial report may be listed.

In some embodiments the indexing application 244 may provide storage of templates and storage of data received for reporting. In this way, the indexing application 244 may be in communication with the compliance tool application 256 to send data to the compliance tool application 256 for the generation and processing of the compliance adherence assessment tool to ensure standardized, uniform, and accurate regulatory reporting of financials.

FIG. 2 also illustrates a user system 204. The user system 204 is operatively coupled to the entity server 208, group systems 210, and/or the regulatory data database server 206 through the network 201. The user system 204 has systems with devices the same or similar to the devices described for the entity server 208 and/or the regulatory data database server 206 (e.g., communication device, processing device, and memory device). Therefore, the user system 204 may communicate with the entity server 208, group systems 210, and/or the regulatory data database server 206 in the same or similar way as previously described with respect to each system. The user system 204, in some embodiments, is comprised of systems and devices that allow for a user 202 to access authorized portions of the compliance adherence assessment tool for regulatory reporting. The user system 204 also allows for the input of data from one or more users onto the tool for reporting and compliance purposes. A “user device” 204 may be any mobile or computer communication device, such as a cellular telecommunications device (e.g., a cell phone or mobile phone), personal digital assistant (PDA), a mobile Internet accessing device, or other mobile device including, but not limited to portable digital assistants (PDAs), pagers, mobile televisions, gaming devices, laptop computers, desktop computers, cameras, video recorders, audio/video player, radio, GPS devices, any combination of the aforementioned, or the like. Although only a single user system 204 is depicted in FIG. 2, the system environment 200 may contain numerous user systems 204, as appreciated by one of ordinary skill in the art.

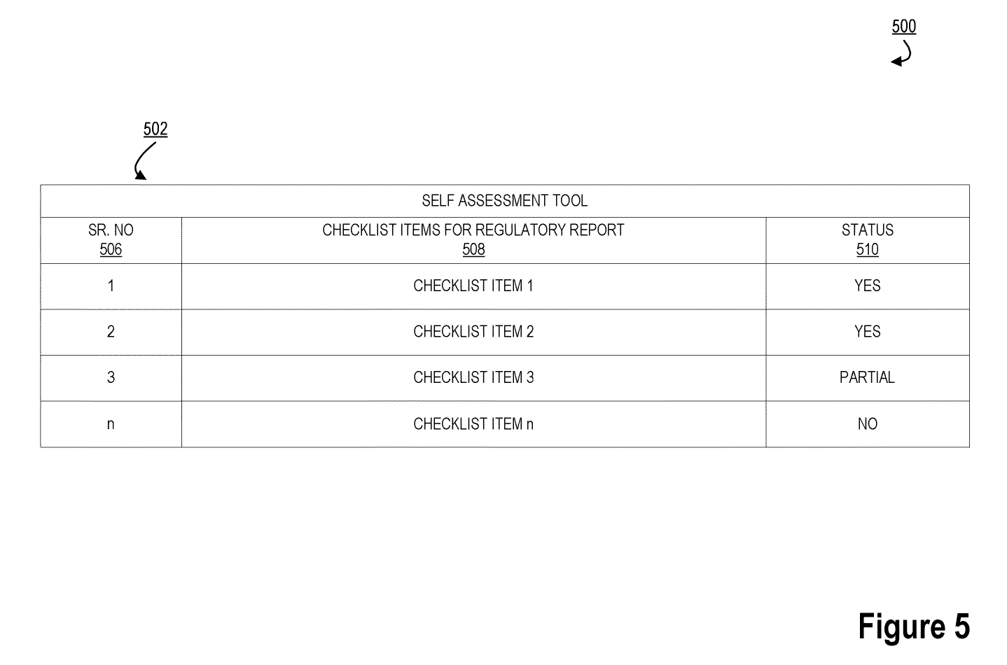

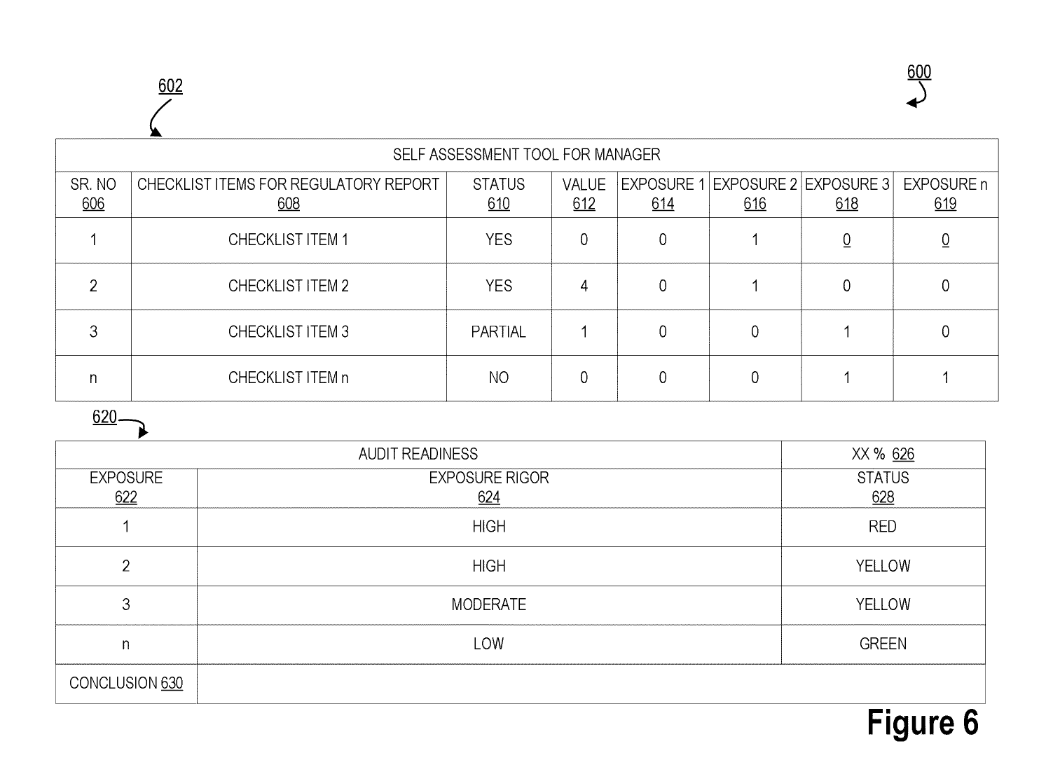

The compliance tool application 256 may identify the user system 204 accessing or attempting to access the compliance adherence assessment tool for regulatory reporting based on the user system 204 identification information, such as an internet protocol address or the like. Once the user system 204 is identified, the compliance tool application 256 may present the user 202 via the user system 204 with the authorized amount of data for that user system 204. In this way, some users 202 may have access to more portions of the tool, such as exposure ratings, values, current status, or the like which are further illustrated below with respect to FIG. 5 and FIG. 6.

FIG. 2 also illustrates group systems 210. The group systems 210 are operatively coupled to the entity server 208, user system 204, and/or the regulatory data database server 206 through the network 201. The group systems 210 has systems with devices the same or similar to the devices described for the entity server 208 and/or the regulatory data database server 206 (e.g., communication device, processing device, and memory device). Therefore, the group systems 210 may communicate with the entity server 208, user system 204, and/or the regulatory data database server 206 in the same or similar way as previously described with respect to each system. The group systems 210, in some embodiments, are comprised of systems and devices that allow for accessing and imputing on the compliance adherence assessment tool for regulatory reporting. In some embodiments, the group systems 210 may also generate documents and other data for reports. In yet other embodiments, the group systems 210 may generative regulatory reports for the group within the entity. Furthermore, group systems 210 may receive populated templates based on data the group systems 210 provided. In some embodiments, group systems 210 and user systems 204 may be interchangeable within the system 200. In this way, the group systems 210 are associated with groups such as lines of business, groups, subsidiaries, business partners, or the like associated with the entity.

FIG. 2 depicts only one group systems 210 within the computing system environment 200, however, one of ordinary skill in the art will appreciate that a plurality of group systems 210 may be communicably linked with the network 201 and the other devices on connected to the network 201, such that each group systems 210 is communicably linked to the network 201 and the other devices on the network 201.

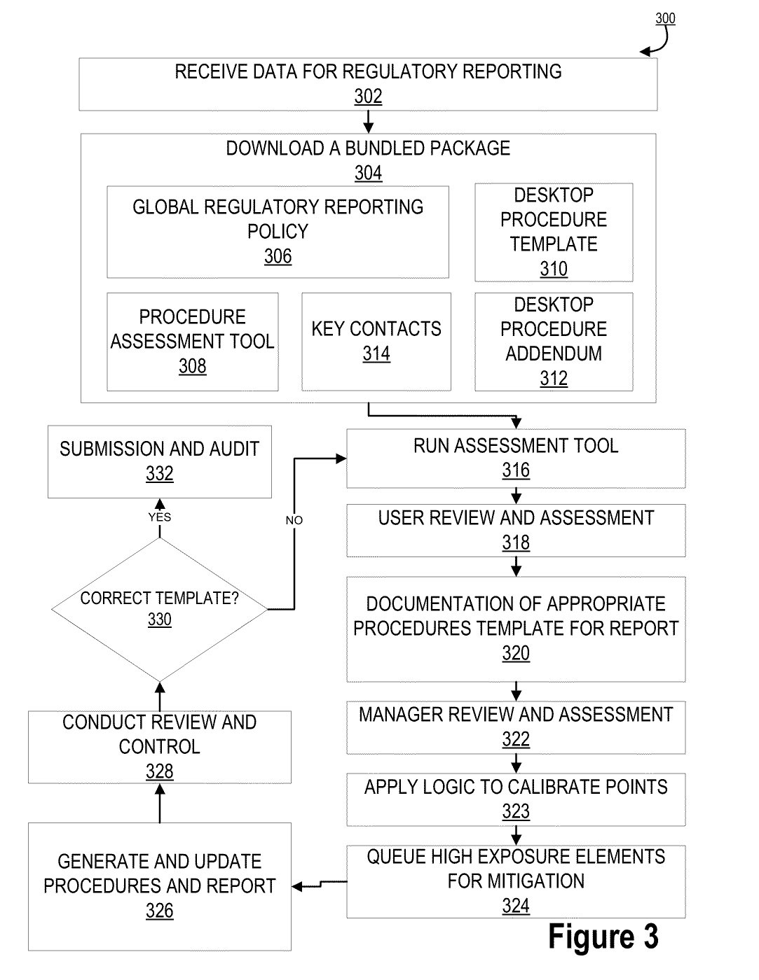

FIG. 3 illustrates a process flow illustrating the regulatory reporting compliance adherence assessment technique 300, in accordance with embodiments of the invention. The process 300 is initiated by receiving data for regulatory reporting, as illustrated in block 302. This data may be received by groups within the entity that have compiled the data over the course of a reporting period for the report. In some embodiments, this data may also be received from a compliance section or group within the entity. This may include new global regulatory compliant procedures or updates to current procedures. In some embodiments, the data may be received from one or more local or federal government sources that may require specific financial reporting. In some embodiments, the data may be one or more regulatory reports for the group.

Next, as illustrated in block 304, the process 300 continues by downloading a bundled package for preparation of application of the compliance adherence assessment tool for regulatory reporting. The bundled package includes the entity's global regulatory reporting policy 306, procedure assessment tools 308, key contact information 314, desktop procedure templates 310, and desktop procedure addendums 312.

In some embodiments, the entity's global regulatory reporting policy 306 is a policy implemented by the entity for reporting financials. This report may include what data to include in reporting, how to use the data for reporting, logistics of the reporting (i.e. when to report, whom to report to, formatting of the report, or the like), or the like. The global regulatory reporting policy 306 may include instructions or information about how the entity requires reporting procedures to be done for each of the one or more groups and/or financial reports. In this way the global regulatory reporting policy 306 includes entity wide and local group policies about reporting each of the one or more finances that may require reporting.

In some embodiments, the bundled package 304 includes procedure assessment tools 308. Procedure assessment tools 308 are tools that ensure compliance adherence and standardized reporting across an entity. The tool may include specific procedures that need to be followed to complete the report and prepare for audit readiness. Furthermore, procedure assessment tools 308 include assessments required for the one or more various financial reports. In this way, some financials may require various different procedures to prepare the data for reporting. As such, the different procedures may need to be followed by a user 202 and/or by the tool depending on the report and/or the policies associated with that report. Subsequently, the system assesses to ensure that the required procedures are followed for each of the one or more reports. The procedure assessment tool may include several features described throughout this application, which may include incorporating checklist items for each report, generating a status update for each of the checklist items of the report, creating value scores for the exposure items of each of the checklist items, presenting grids associated with exposure impact for each of the one or more exposure items, allowing authorized users 202 input into exposure element rankings, and the

In some embodiments, also included in the bundled package 304 for preparation of application of the compliance adherence assessment tool for regulatory reporting includes the key contacts 314 for that report. In this way, contact information for the key contact 314 responsible for the specific financial report may be listed. The key contact 314 may be a contact within the group within the entity associated with the report may be listed in the tool such that he/she may be contacted for additional data, for the key contact's review of the report, or the like.

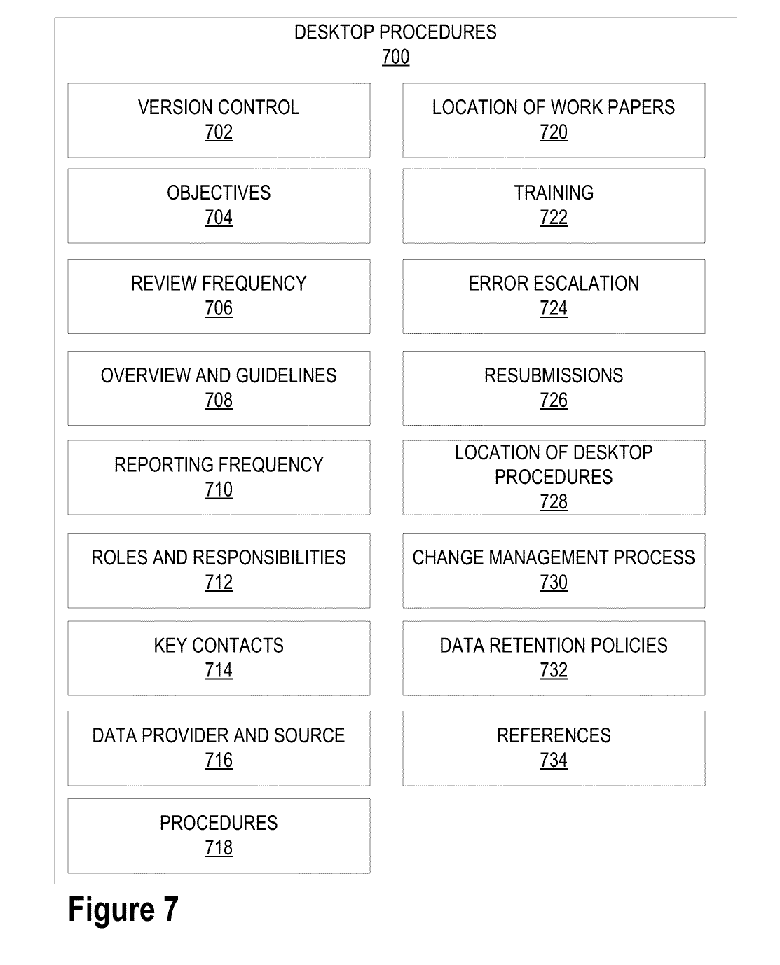

In some embodiments, the bundled package 304 includes a desktop procedure template 310. Each of the one or more reports may require a different template or additions/subtractions to a standard template. In this way, the bundled package 304 may include the appropriate desktop procedure template for the financial report. Information associated with a desktop procedure template is illustrated below in FIG. 7.

Finally, the bundle package 304 includes any desktop procedure addendum 312 that may be required for the particular report based on updates received from the entity and/or the local or federal regulators. Addendums may include one or more updates, changes, or new implementations to the desktop procedure based on regulatory guidelines or local regulations.

Once the bundled package 304 of information required for that particular financial report has been downloaded, the process 300 may continue by having a user 202 prepare and run the assessment tool for self assessment 316. In this way, the compliance adherence assessment tool for regulatory reporting may be initially prompted such that all of the bundled package 304 for a single report may be incorporated into the tool. The tool incorporates the bundled package 304 of data with data inputted from a preparer. The data from the preparer is all of the required financial data necessary for the report, and/or the report. This financial data may include any data required from the policy or regulations, such as revenue, income, or the like. Once ran, the tool may continue to monitor and access the current status of the checklist items associated with the desktop procedures for report compliance. In this way, the tool may run all checklists and indicate to a user 202. These checklists monitored by the assessment tool includes monitoring whether procedures were correctly followed for that desktop procedures, objectives for the report were clear and met, the report history, the report frequency, and the like.

In some embodiments, once the compliance adherence assessment tool for regulatory reporting incorporates the bundled package and reporting data and subsequently runs checklists monitoring the status of various checkpoints associated with the reporting, the tool may internally measuring potential gaps in the regulatory reporting process. In this way, the tool may identify one or more exposure areas or other gaps in the reporting process for that particular financial report and group associated therewith. These gaps may be presented to the key contact if necessary. The compliance adherence assessment tool for regulatory reporting then creates an interface for user 202 visualization via a user device 204.

Next, as illustrated in block 318, a user 202, such as the preparer, may review and assess the status of the compliance adherence assessment tool for regulatory reporting via an interface. In this way, a compliance adherence assessment tool for regulatory reporting is presented to the appropriate user 202 within the entity. The assessment tool interface associated with the compliance adherence assessment tool for regulatory reporting that the user 202 may be presented with is further illustrated below with respect to FIG. 5. The user 202 may be the preparer of the report, compiler of data for the report, or a compliance associate associated with the entity.

FIG. 5 illustrates an assessment tool interface associated with the compliance adherence assessment tool for regulatory reporting 500, in accordance with embodiments of the invention. As illustrated in section 502, the system generates an assessment tool for the preparer to view. In this way, the preparer may identify the items, the checklist, and the status of completion of each of the items. Each of the items may vary depending on the global regulatory reporting policy and/or local regulations for that particular financial report. As illustrated in the self assessment tool 502, there is presented a column ranking the checklist items, as illustrated in section 506. There may be one or more checklist items ranked in the self assessment tool 502 based on the financial report being generated. As illustrated in the interface 502, the number of checklist items include 1, 2, 3, up to n. In the next column the interface 502 provides a detailed description of the checklist item, as illustrated in section 508. These checklist items are based on the report being generated. They may include items such as if the desktop procedure is already in place, if the report objectives are clear, or if the desktop procedure review frequency is correct. In the interface illustrated in FIG. 5 there are Checklist Item 1, Checklist Item 2, Checklist Item 3, and Checklist Item n. Next, as illustrated in section 510, the preparer may also be able to view the current status of each of the checklist items. This way the preparer may know which of the items need to be completed in order to finalize the report. In the example illustrated in FIG. 5, some of the checklist items are complete, as indicated by a “yes” in the status section 510, while other items are partially complete, as indicated by a “partial” in the status section 510, or not started as indicated by a “no” in the status section 510.

Referring back to FIG. 3, the process 300 continues at block 320 where the system may generate and document an appropriate procedure template for the specific financial report data for a desktop procedure for the report. In this way, the selected template may match the required global regulatory reporting policy and regulations associated with the same. In this way, the preparer has completed all or most of the checklist to ensure compliance adherence and the desktop procedures for preparing the report are being generated based on the template and desktop procedure addendums identified for the report.

Next, the desktop procedures generated may be ready for review and assessment by a manager or other user 202, as illustrated in block 322. The manager or business controller may have access to view the exposure elements for each of the checklist items. The manager may also have the ability to manually input a number or weight to each of the exposure elements across each checklist item to identify the highest importance exposure for that particular group within the entity for subsequent mitigation of the exposure. The manager may be presented with a manager's assessment tool interface associated with the compliance adherence assessment tool for regulatory reporting, which is further illustrated below with respect to FIG. 6.

FIG. 6 illustrates a manager's assessment tool interface associated with the compliance adherence assessment tool for regulatory reporting 600, in accordance with embodiments of the invention. The manager's assessment tool interface 602 is similar to the preparer's assessment tool interface 502, however the manager may have access to several more data points. In this way, the manager may be able to input ranks for exposure elements for each of the checklist items, edit the exposure element ranking, or the like for each of the one or more checklist items. These ranks of various exposure elements for each checklist provide an indication to the entity as to the importance of each of the reports and the exposure associated with each report such that the negative impact of the potential exposure elements may be mitigated by the entity prior to reporting.

As illustrated in FIG. 6, the system generates an assessment tool for the manager 602 to view. In this way, the manager may identify the items, the checklist, the status of completion of each of the items, the exposure value, and each of the exposure elements for the report. Each of the serial numbers may vary depending on the global regulatory reporting policy and/or local regulations for that particular financial report. Furthermore, the manager may be able to provide an overall value for each checklist item as well as rank of negative exposure for each of the checklist items. As illustrated in the manager's self assessment tool 602, there is presented a column ranking the checklist items, as illustrated in section 606. There may be one or more checklist items ranked in the manager's self assessment tool 602 based on the financial report being generated. As illustrated in the interface 602, the number of checklist items include 1, 2, 3, up to n. In the next column the interface 602 provides a detailed description of the checklist item, as illustrated in section 608. These checklist items are based on the report being generated. They may include items such as if the desktop procedure is already in place, if the report objectives are clear, or if the desktop procedure review frequency is correct. In the interface illustrated in FIG. 6 there are Checklist Item 1, Checklist Item 2, Checklist Item 3, and Checklist Item n. Next, as illustrated in section 610, the manager may also be able to view the current status of each of the checklist items. This way the manager may be able to view the progress of the preparer based on deadlines or the like. Thus, the manager may be able to identify which of the items need to be completed in order to finalize the report. In the example illustrated in FIG. 6, some of the checklist items are complete, as indicated by a “yes” in the status section 610, while other items are partially complete, as indicated by a “partial” in the status section 610, or not started as indicated by a “no” in the status section 610.

Furthermore, the manager's self assessment tool 602 includes several columns that a manager may have access to. First, the manager's self assessment tool 602 includes a value section 612. The value section 612 includes a column of values of a combination of the exposures ratings for each of the checklist items. Furthermore, the exposure rating value 612 may include a weighted combination value of the exposures for each of the checklist times within the report. These values 612 may include a ranking of numbers, in the illustration provided in FIG. 6, Checklist Item 1 has a 0 value for exposure, Checklist Item 2 has a 4 value for exposure which may indicate a greater chance of exposure for the checklist item. As such, the manager may attempt to review the checklist item and the report overall in an attempt to mitigate the exposure for that exposure element.

The self assessment tool for managers 602 includes exposure element rankings that are totaled for the value section 612. The exposure elements may be one or more items based on the report being generated. In the embodiment illustrated in FIG. 6, the exposure elements include Exposure 1 614, Exposure 2 616, Exposure 3 618, and up to Exposure n 619. The manager and/or the system may generate a value ranking for the negative exposure for each exposure element. As such, a rating is created and displayed via the self assessment tool for managers 602.

Furthermore, the manager or other authorized user 202 may be able to edit the ranking number given for the exposure element of each checklist item. In this way, the manager may be able to identify the one or more items that may have the most potential negative exposure if not mitigated. In this way, the manager may be able to input into the self assessment tool 602 one or more indications as to how much exposure each item may have on the manager's line of business. In this way, compliance associates and other users may be able to identify the one or more areas that may require more review to ensure a mitigation of exposure for that financial report.

Furthermore, the manager may be able to view, via an audit readiness interface 620 as part of the assessment tool interface associated with the compliance adherence assessment tool for regulatory reporting 600, the readiness for auditing prepared by the system. In this way, the system may compile the data for the report, including the financial data and the bundled package data and apply logic, such as in the form of an algorithm with weighted factors to identify the exposure for various exposure elements that may be relevant to the specific report. The audit readiness interface 620 may present an overall percent of audit readiness for the report, as illustrated in 626. This is generated by the system for a quick view as to the stage of the report for audit purposes. The various potential exposure elements are illustrated in the column of section 622. These exposure elements may include regulatory, monetary, legal, or the like exposure elements. Depending on the report, there may be one or more exposure elements 622 listed in the column. In this example there are 1, 2, 3, up to n exposure elements 622. The exposure rigor is also listed in section 624. The exposure rigor provides an illustration of the system generated importance of the potential exposure associated with that report. The exposure rigor may be high, moderate, or low rigor. In this way, the particular report may have high/moderate/low exposure relating to regulatory, monetary, legal, or the like exposures. Finally, the status of mitigation of that exposure may be presented in the status section 628. In this way, the entity may provide additional review of data or other steps to mitigate the exposure rigor associated with the particular exposure element. The status of that mitigation is illustrated as red, yellow, or green, with green being the highest mitigated of the exposures. Finally, as illustrated in section 630, the system may present a conclusion to the audit readiness of the particular report.

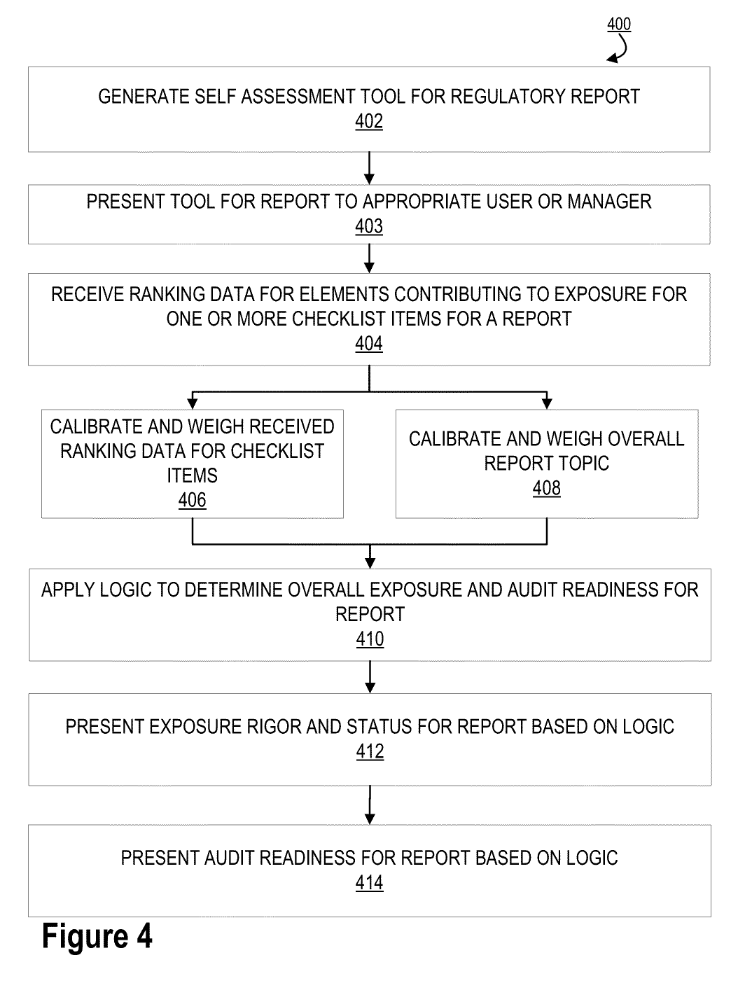

Referring again back to FIG. 3, once the manager has reviewed and assessed the manager assessment tool for the particular desktop procedures for the financial report being generated, the process continues by applying logic to calibrate the points or rankings inputted by the manager, as illustrated in block 323. In some embodiments, the logic applied may correlate to generating the audit readiness interface 620. The process of calibration for identification of high exposure factors if further illustrated in FIG. 4.

FIG. 4 illustrates a detailed process for the process of calibrating for identification of high exposure factors 400, in accordance with an embodiment of the invention. As illustrated in block 402, the process 400 is initiated when a self assessment tool for regulatory reporting is generated. This may be for a preparer and/or manager. In this way, there may be one or more columns for values of exposure elements for each of the one or more checkpoint items associated with a financial regulatory report. Next, as illustrated in block 403, the tool is presented to the user via a user device 204. As illustrated in block 404, the system may receive ranking data, in the form of scores, for the exposure elements contributing to potential negative exposure for one or more checklist items for a financial regulator report.

The system may continue by calibrating and weighing the received ranking data or scores provided by the manager, as illustrated in block 406. The system may determine, using logic, a weight to apply to each of the one or more scores provided. Also, the system may calibrate and weigh the overall report topic, as illustrated in block 408. In this way, for each exposure element, the weight may be different depending on the financial report that is being generated or audited. As such, the weighing of the exposure elements may be fluid and applied differently at each report depending on the nature of the report and exposure potential for each report within the entity. In some embodiments, the system may learn based on historic data and historic reporting as to which of the one or more exposures should be weighed. Furthermore, the change in the tool makes for maturity and guidelines to continually gain the best practice for reporting each of the one or more financial issues. As such, the system becomes more granular overtime.

As illustrated in block 410, the logic is applied to determine an overall exposure and/or audit readiness for each report. The logic applied may be an algorithm, learned artificial intelligence based on prior weeks/months/years of reporting, manager input, or the like and/or a combination thereof. As such, while some checklist items may receive one or more scores for exposure elements, these scores may be weighted more or less based on the particular exposure, the group, the report topic, or the like. The logic identifies the high exposure reports for mitigation.

Next, as illustrated in block 412, the exposure rigor and status for the report based on the logic applied may be presented via an interface, such as the audit readiness interface 620. In this way, the overall audit readiness may be viewable by a user 202 to ensure completion of the report and compliance adherence for the same. Finally, the completed audit readiness report may be presented to a user 202 via the audit readiness interface 620, as illustrated in block 414.

Referring again back to FIG. 3, once the system has applied logic to calibrate and weigh the points associated with exposure elements associated with each of the one or more checklist items for a desktop procedure for a report, as illustrated in block 323, the system may continue to queue reports with high exposure elements for further mitigation, as illustrated in block 324. At this point, the manager or other users within the entity may review data associated with that report in an attempt to further mitigate any possible exposure associated therewith.

Subsequently, as illustrated in block 326, the process 300 may continue when the system generates and updates procedures documentation, such as the desktop procedures for the reports based on the exposure mitigation. A subsequent review and control of the desktop procedures may be performed, as illustrated in block 328. In some embodiments, the review may be done by a manager. In other embodiments, the review may be done by a preparer. In yet other embodiments, the review may be done by a compliance associate and/or the system.

The system may then determine if the desktop procedures template for this particular report is correct in decision block 330. In this way, the system may run a check to confirm the compliance adherence for the regulatory report and the readiness for auditing for the report to be generated and formatted from the desktop procedure template. If the desktop procedures template is determined to not be correct in decision block 330, then the system restarts the running of the assessment tool in block 316 to re-run for compliance adherence and audit readiness for the one or more regulatory reports. If the desktop procedure template is correct in decision block 330, the process 300 ends by submission of the desktop procedures template and storage of the audit readiness for the report for subsequent audit necessities. For audit readiness, the system may now prepare the entity for regulatory reporting and audit readiness based on the populated report. In this way, the populated desktop procedures for compliance and regulatory reporting is finalized and the system also takes the data and prepares it for audit readiness. Audit readiness compiles the data into one or more formats for easy audit viewing and responsiveness.

FIG. 7 illustrates the items within one or more desktop procedures generated for a regulatory report 700, in accordance with embodiments of the invention. While FIG. 7 is illustrated as a box or flow diagram, one of ordinary skill in the art will appreciate that each of the one or more items may be included in a document template, which may include one or more headings, indexes, cover sheets, and formatting required for each of the one or more reports that may be required to be generated.

The version control section 702 provides a section in the desktop procedures 700 were the various versions of that particular desktop procedure 700. In this way, the version control section 702 may include the date the version was last updated, when it was reviewed, who reviewed it, who updated it, and if there are any review or update details. The objectives section 704 provide an introduction to the desktop procedure 700 for regulatory reporting. These objectives gives a user an indication as to why the desktop procedure 700 are being presented. Next, as illustrated in section 706, the review frequency required for that particular report and/or desktop procedure 700 is laid out for the user. The overview and guidelines section 708 provides the user with a brief overview of the desktop procedure 700 and guidelines for creating the regulatory report based on the desktop procedure 700. Next, section 710 provides the reporting frequency necessary for that specific financial data set. As such, the desktop procedure 700 may require a user to report the daily, weekly, monthly, semi-annually, fortnightly, every X-days, quarterly, or annually.

As illustrated in section 712, the desktop procedure 700 may include a section for roles and responsibilities. This section 712 includes a table for each team and their function or responsibility to ensure that an effective control environment is designed and effective means to mitigate exposures of reporting discrepancies. These roles and responsibilities may include, but are not limited to the desktop procedure, preparing the report, completely the report, reviewing the report, signing off on the report, certifying the report, escalation, and report requirement data ownership. Section 714 includes key contacts for the report. The key contacts may include the preparer, reviewer, regional reporting manager, controller, compliance associate, corporate audit, and/or legal.

As illustrated in section 716, the desktop procedure 700 continues to include data providers and data sources. This section 716 may include the type of date required, the system name, data source, business owner, gathering time, data retention period, and the like. Next, as illustrated in section 718, the desktop procedure 700 includes a procedures section. The procedures section 718 includes an illustration with text and/or flow diagrams for the preparation, review, submission, and sign-off for creating the report. The location of work papers section 720 includes a folder or pathway for each of the one or more documents necessary for the report.

Continuing in FIG. 7, the desktop procedure 700 includes a training section 722. The training section 722 illustrates one or more training courses necessary to complete (either internally or externally) before performing as a data preparer or reviewer. There may also include various continuing courses required to maintain the preparer or reviewer status. Next, as illustrated in section 726, the desktop procedure 700 presents the user 202 with resubmission guidelines. Section 728 includes the location of desktop procedures, which provides an indication as to the location in which the desktop procedures for this report have been saved. Section 730 provides for change management processes. The change management process section 730 includes an indication if any new products or new activities have been implemented since the last reporting period. The data retention policies section 732 includes information on development and maintenance of data retention processing as well as details of a business continuity planning Finally, as illustrated in section 734, the desktop procedure 700 ends with references required for the building of the procedure.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, or the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational phases to be performed on the computer or other programmable apparatus to produce a computer-implemented process such that the code portions which execute on the computer or other programmable apparatus provide phases for implementing the functions/acts specified in the flowchart and/or block diagram block(s). Alternatively, computer program implemented phases or acts may be combined with operator or human implemented phases or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that phases of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for compliance adherence for financial regulatory reporting, the system comprising:
a memory device with computer-readable program code stored thereon;
a communication device;
a processing device operatively coupled to the memory device and the communication device, wherein the processing device is configured to execute the computer-readable program code to:
generate a procedure template for regulatory reporting;
update the procedure template with policies and local regulations for a specific financial report;
present assessment tool for the financial report to a user via an interface, wherein the assessment tool provides a checklist of items to complete for compliance and an order associated therewith;
receive ranking of exposure elements for each of the checklist of items;
apply logic to received ranking of exposure elements to identify weighted exposure ranking for each of the checklist of items to identify impactful exposures, wherein the weighted exposure rank is based on the received rank of the exposure elements, the checklist item associated with the exposure elements, and the financial report;
update the procedures template for the financial report with mitigation steps for the impactful exposures, wherein the updating creates a unique procedures template for the financial report;
provide the unique procedures template to initiate financial report creation; and
create uniform financial reports across an entity using unique procedures templates created for each of the required financial reports across the entity.

2. The system of claim 1 further comprises generating an audit readiness assessment tool displaying the readiness of each of the financial reports across the entity based on the mitigation steps completed for the impactful exposures for the financial reports.

3. The system of claim 1, wherein presenting the assessment tool further comprises determining the authorization level of the user being presented with the assessment tool and changing an amount of data presented to the user based on the authorization level of the user.

4. The system of claim 1, wherein the assessment tool further comprises an input for ranking a negative exposure for each of the checklist items across each of the exposure elements.

5. The system of claim 1, wherein the exposure factors include one or more of regulatory exposures, legal exposures, or monetary exposure.

6. The system of claim 1, wherein the unique procedures template further comprises reporting frequency, key contacts, and procedures unique to each of the financial reports required for an entity.

7. The system of claim 1 further comprising receiving a global regulatory reporting policy from the entity and local regulations to incorporate into the procedure template for the financial report associated with the global regulatory reporting policy from the entity or local regulations.

8. A computer program product for compliance adherence for financial regulatory reporting, the computer program product comprising at least one non-transitory computer-readable medium having computer-readable program code portions embodied therein, the computer-readable program code portions comprising:
an executable portion configured for generating a procedure template for regulatory reporting;
an executable portion configured for updating the procedure template with policies and local regulations for a specific financial report;
an executable portion configured for presenting assessment tool for the financial report to a user via an interface, wherein the assessment tool provides a checklist of items to complete for compliance and an order associated therewith;
an executable portion configured for receiving ranking of exposure elements for each of the checklist of items;
an executable portion configured for applying logic to received ranking of exposure elements to identify weighted exposure ranking for each of the checklist of items to identify impactful exposures, wherein the weighted exposure rank is based on the received rank of the exposure elements, the checklist item associated with the exposure elements, and the financial report;
an executable portion configured for updating the procedures template for the financial report with mitigation steps for the impactful exposures, wherein the updating creates a unique procedures template for the financial report;
an executable portion configured for providing the unique procedures template to initiate financial report creation; and
an executable portion configured for creating uniform financial reports across an entity using unique procedures templates created for each of the required financial reports across the entity.

9. The computer program product of claim 8 further comprises an executable portion configured for generating an audit readiness assessment tool displaying the readiness of each of the financial reports across the entity based on the mitigation steps completed for the impactful exposures for the financial reports.

10. The computer program product of claim 8, wherein presenting the assessment tool further comprises determining the authorization level of the user being presented with the assessment tool and changing an amount of data presented to the user based on the authorization level of the user.

11. The computer program product of claim 8, wherein the assessment tool further comprises an input for ranking a negative exposure for each of the checklist items across each of the exposure elements.

12. The computer program product of claim 8, wherein the exposure factors include one or more of regulatory exposures, legal exposures, or monetary exposure.

13. The computer program product of claim 8, wherein the unique procedures template further comprises reporting frequency, key contacts, and procedures unique to each of the financial reports required for an entity.

14. The computer program product of claim 8 further comprising an executable portion configure for receiving a global regulatory reporting policy from the entity and local regulations to incorporate into the procedure template for the financial report associated with the global regulatory reporting policy from the entity or local regulations.

15. A computer-implemented method for compliance adherence for financial regulatory reporting, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
generating a procedure template for regulatory reporting;
updating the procedure template with policies and local regulations for a specific financial report;
presenting assessment tool for the financial report to a user via an interface, wherein the assessment tool provides a checklist of items to complete for compliance and an order associated therewith;
receiving ranking of exposure elements for each of the checklist of items;
applying, via a computer device processor, logic to received ranking of exposure elements to identify weighted exposure ranking for each of the checklist of items to identify impactful exposures, wherein the weighted exposure rank is based on the received rank of the exposure elements, the checklist item associated with the exposure elements, and the financial report;
updating the procedures template for the financial report with mitigation steps for the impactful exposures, wherein the updating creates a unique procedures template for the financial report;
providing the unique procedures template to initiate financial report creation; and
creating uniform financial reports across an entity using unique procedures templates created for each of the required financial reports across the entity.

16. The computer-implemented method of claim 15 further comprises generating an audit readiness assessment tool displaying the readiness of each of the financial reports across the entity based on the mitigation steps completed for the impactful exposures for the financial reports.

17. The computer-implemented method of claim 15, wherein presenting the assessment tool further comprises determining the authorization level of the user being presented with the assessment tool and changing an amount of data presented to the user based on the authorization level of the user.

18. The computer-implemented method of claim 15, wherein the assessment tool further comprises an input for ranking a negative exposure for each of the checklist items across each of the exposure elements.

19. The computer-implemented method of claim 15, wherein the exposure factors include one or more of regulatory exposures, legal exposures, or monetary exposure.

20. The computer-implemented method of claim 15 further comprising receiving a global regulatory reporting policy from the entity and local regulations to incorporate into the procedure template for the financial report associated with the global regulatory reporting policy from the entity or local regulations.
